(19) United States
(12) Patent Application Publication
(10) Pub. No.: US 2025/0031681 A1
(43) Pub. Date: Jan. 30, 2025

(54) SPINCAST FRONT COVER ATTACHMENT

(71) Applicant: Pure Fishing, Inc., Spirit Lake, IA (US)

(72) Inventor: Cameron Ivie, Irmo, SC (US)

(21) Appl. No.: 18/782,183

(22) Filed: Jul. 24, 2024

Related U.S. Application Data
(60) Provisional application No. 63/516,165, filed on Jul. 28, 2023.

(51) Int. Cl. A01K 89/015

(52) U.S. Cl. CPC A01K 89/01921

(57) ABSTRACT

The present invention is a cover attachment mechanism for a spincast reel. The reel includes a main body, a cover, and a locking mechanism. The locking mechanism further includes cams and the cover further includes cam receiving features. The cams of the locking mechanism can be selectively positioned to secure the cover to the main body or to release the cover from the main body without requiring rotation of the cover.

### CROSS-REFERENCE TO RELATED APPLICATION

The present application claims priority to U.S. Provisional Patent Application No. 63/516,165 filed Jul. 28, 2023, entitled “SPINCAST FRONT COVER ATTACHMENT,” the entire contents of which are hereby incorporated by reference.

### FIELD OF THE INVENTION

The present invention relates generally to a cover for a spincast reel. More particularly, the invention relates to a locking mechanism that allows the cover to be easily secured or detached from a main body of the reel and allows for complex engagement geometries between the cover and the main body of the reel.

### BACKGROUND OF THE INVENTION

The present invention provides an attachment method for the front cover of a spincast reel that is both easily engaged/disengaged and allows for complex geometry between the front cover and body of the spincast reel. Spincast reels typically include a front cover, often referred to as a “cone.” The cone is placed over the spool and rotor, which control the line and guide it to the rotor's pick-up pins for retrieval. Historically, this cone has been attached to the reel by either a threaded attachment or a similar “bayonette” style cam. In either case, rotational movement of the cone is used to attach the cone to the reel. The cone is then held in place by the friction of the thread or bayonette feature. The requirement for rotational movement limits the geometry of the interface between the “cone” and the body of the reel. Screws have also been used to secure the cone, but these are not as easily removed to allow for the cone to be removed to access the spool area.

### SUMMARY OF THE INVENTION

More particularly, the present invention is a cam system mounted to a main body of a spincast reel, the cam system having relative motion to the body such that it can move between a position that secures a cover to the body and a position that releases the cover from the body. The cam system includes a lock, which in one embodiment is rotatably or slidably mounted to the body. The lock includes at least one cam feature and the cover includes at least one cam receiving feature. When the cover is attached onto the body, the lock is rotated or slides such that the cam feature interacts with the cam receiving feature to secure the cover to the body of the reel. The mating surfaces of the cover and body can be complex shapes and geometries because neither relative rotation or movement is necessary to secure the body and cover to one another.

### BRIEF DESCRIPTION OF THE DRAWINGS

For a better understanding of the present invention, reference may be made to the following accompanying drawings.

FIG. 1 is a perspective view of a spincast reel with a with a front cover in accordance with an embodiment of the present invention.

FIG. 2 is an exploded perspective view showing additional components of the spincast reel of FIG. 1.

FIG. 3 is a perspective view of the lock of FIG. 2.

FIG. 4 is an exploded perspective view of the spincast reel of FIG. 2 showing the lock coupled to a main body of the spincast reel.

FIG. 5 is a perspective view of the front cover of FIG. 1.

FIG. 6 is a section view of the spincast reel with front cover, viewed along section 6-6 of FIG. 4, with the lock shown in a locked position.

FIG. 7 is a section view of the spincast reel with front cover, viewed along section 6-6 of FIG. 4, with the lock shown in an unlocked position.

### DETAILED DESCRIPTION OF THE INVENTION

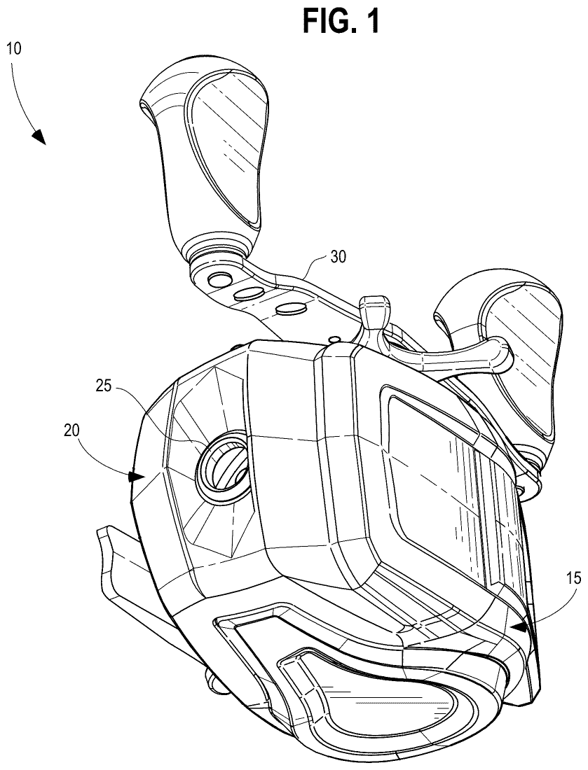

An embodiment of a spincast reel 10 is illustrated in FIG. 1. The reel 10 preferably includes a main body 15 and a front cover 20 that is selectively attachable to the body 15. The body 15 may include a spool and a rotor and gear system for retrieving and casting line, both of which are enclosed by the cover 20 when it is attached to the body 15. The cover 20 can include a line opening 25 near a top end of the cover 20 for the line wrapped around the spool to exit the cover 20 for casting and retrieving of the line. The body 15 may further include a method for switching the reel 10 from a retrieving state to a casting state as commonly known in the art. The reel 10 preferably further includes a handle 30 attached to a side portion of the body 15. The handle 30 can be operated to turn the rotor and gear system to retrieve the cast line and wrap the line around the spool.

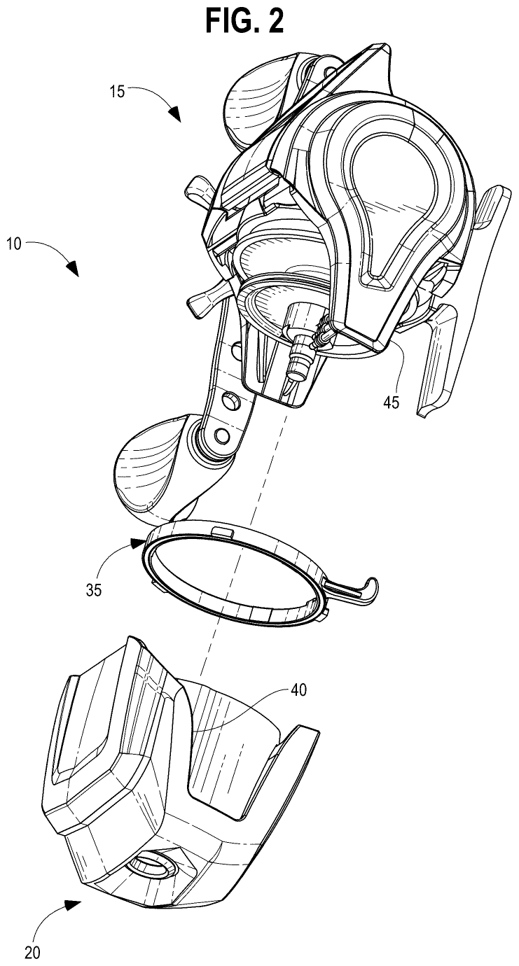

Turning to FIG. 2, the cover 20 of the reel 10 is removed to more clearly illustrate components of the body 15. The reel 10 may further include a lock 35 (shown detached from the body 15) capable of selectively securing the cover 20 to the body 15. The cover 20 may also contain a mating surface 40 that is sized and shaped to fit with a corresponding mounting surface 45 of the body 15. When the cover 20 is attached to the body 15, the mating surface 40 and mounting surface 45 geometries can be configured to help prevent the cover 20 from rotating on the body 15. This allows the body 15 and cover 20 to have unique geometries not previously allowed in prior art spincast reels because prior art reels typically require a cover attachment to rotate or spin to attach to the main body of the reel. The present invention does not require such rotation of the cover 20, but instead uses the lock 35 to secure the cover 20 to the body 15.

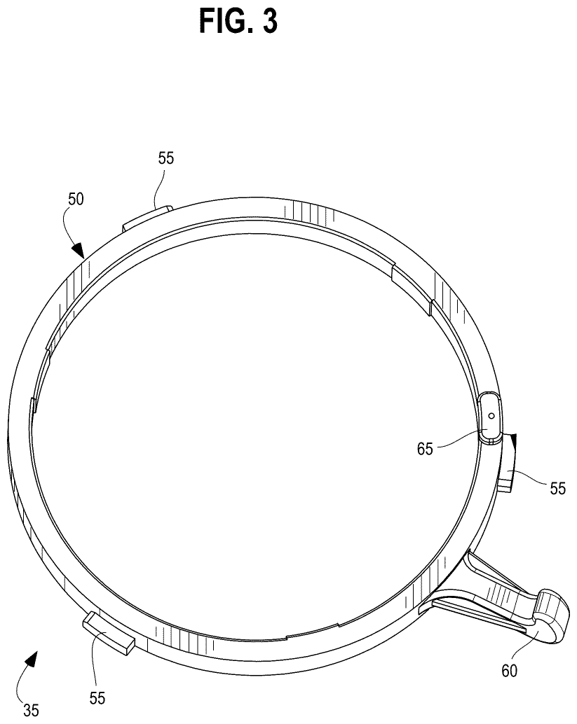

Turning to FIG. 3, the lock 35 may include a circular ring member 50 that includes a number of projections or cams 55 that project radially outward from the ring member 50. The lock 35 may also include a knob 60 that projects radially outward from the ring member 50, which allows for user adjustment of the lock 35. The lock 35 may further include a rotation limiter 65 that projects normally from an upper or lower surface of the ring member 50. The body 15 may include corresponding features that interact with the rotation limiter 65 of the lock 35 to limit the range of rotation of the lock 35. Alternatively, the lock 35 could include cutout features and the body 15 could include projections that protrude into the cutouts and limit the range of rotation of the lock 35.

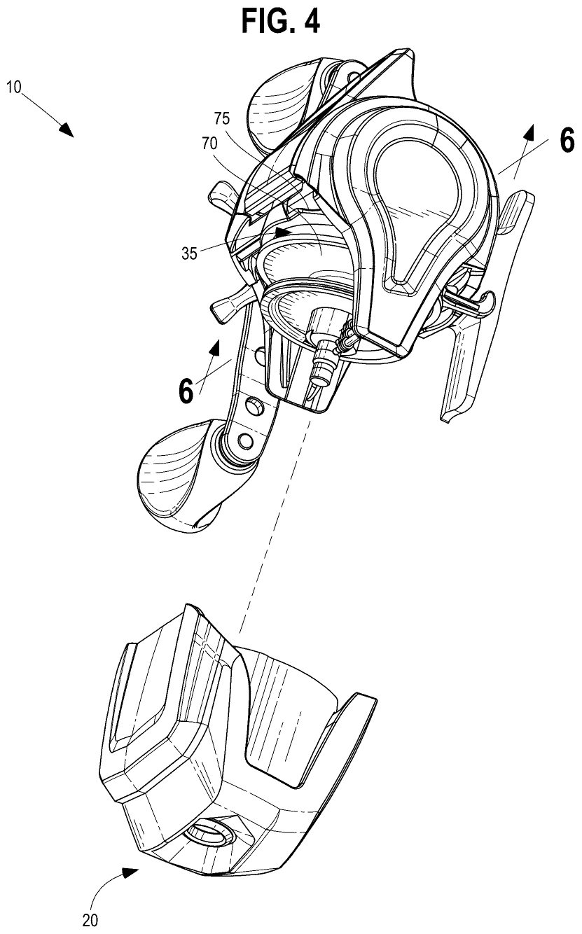

FIG. 4 illustrates the lock 35 coupled to the body 15 in the assembled state of the reel 10. As illustrated, the lock 35 is positioned between a lower end of the spool 70 and an upper surface 75 of the body 15 such that the lock 35 is substantially held in place while still being free to rotate about a central axis of the ring member 50. However, the lock 35 may be coupled to the body 15 in a number of arrangements so long as the lock 35 remains free to rotate about the central axis of the ring member 50 or otherwise slide a minimal distance relative to the body 15.

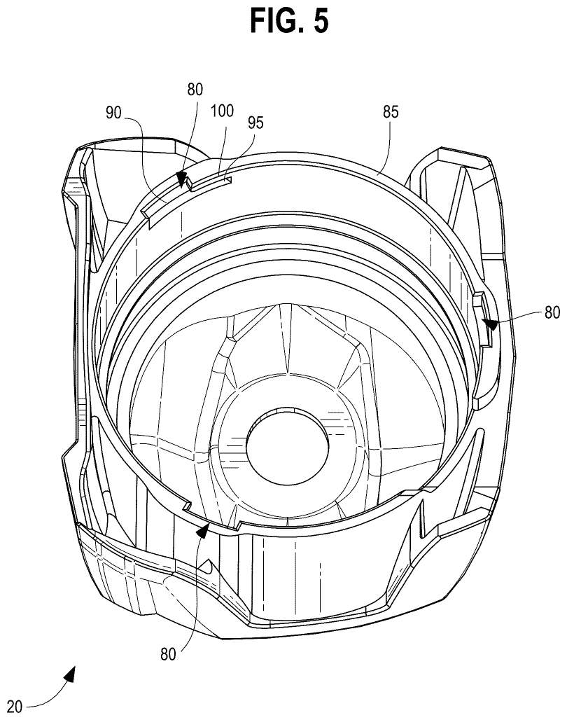

Turning to FIG. 5, the cover 20 may include cutouts or slots 80 for receiving the cams 55 of the lock 35. The slots 80 may be located proximate a bottom end 85 of the cover 20 that mates to the upper surface 75 of the body 15 when the cover 20 is in the attached position. The slots 80 preferably include a first open portion 90 and a second locking portion 95. The open portion 90 may extend to the bottom end 85 of the cover 20 while the locking portion 95 may terminate before the bottom end 85 and instead may have a lip 100 proximate the bottom end 85 of the cover 20. When the cover 20 is attached to the body 15 such that the mounting surface 45 of the body 15 engages with the mating surface 40 of the cover 20, the cams 55 of the lock 35 may insert into the slots 80 of the cover 20. More particularly, the slots 80 may receive the cams 55 through the open portion 90. At this point, the lock 35 may then be rotated by the user such that the cams 55 are rotated into the locking portion 95 of the slots 80. The lip 100 catches on the cams 55 and prevents the cover 20 from moving away from or detaching from the body 15 when the cams 55 are in the locking portion 95 of the slots 80. Rotating the lock 35 back so that the cams 55 are in the open portion 90 of the slots 80 then allows the cover 20 to once again slide away or be removed from the body 15.

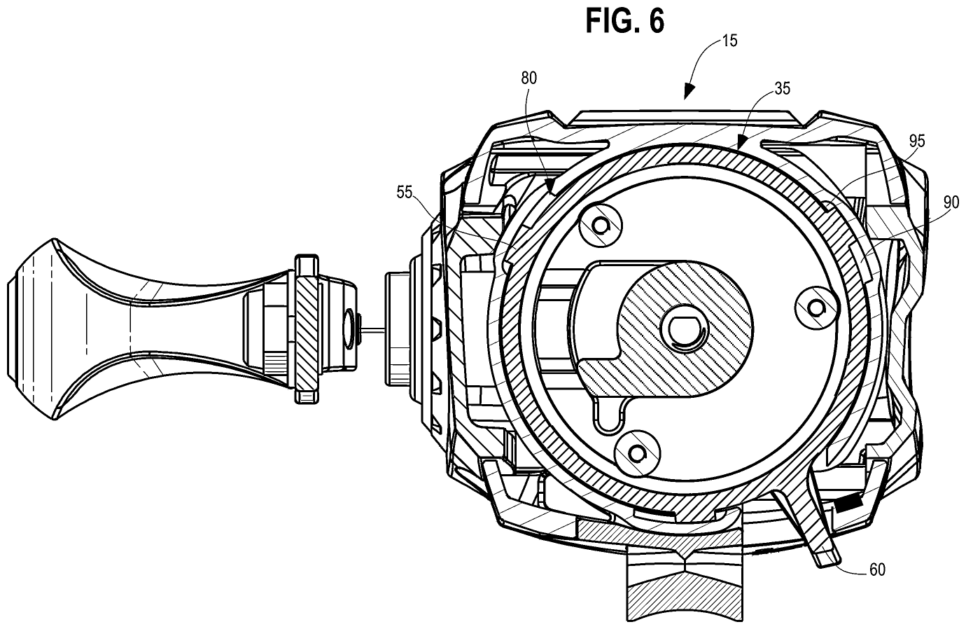

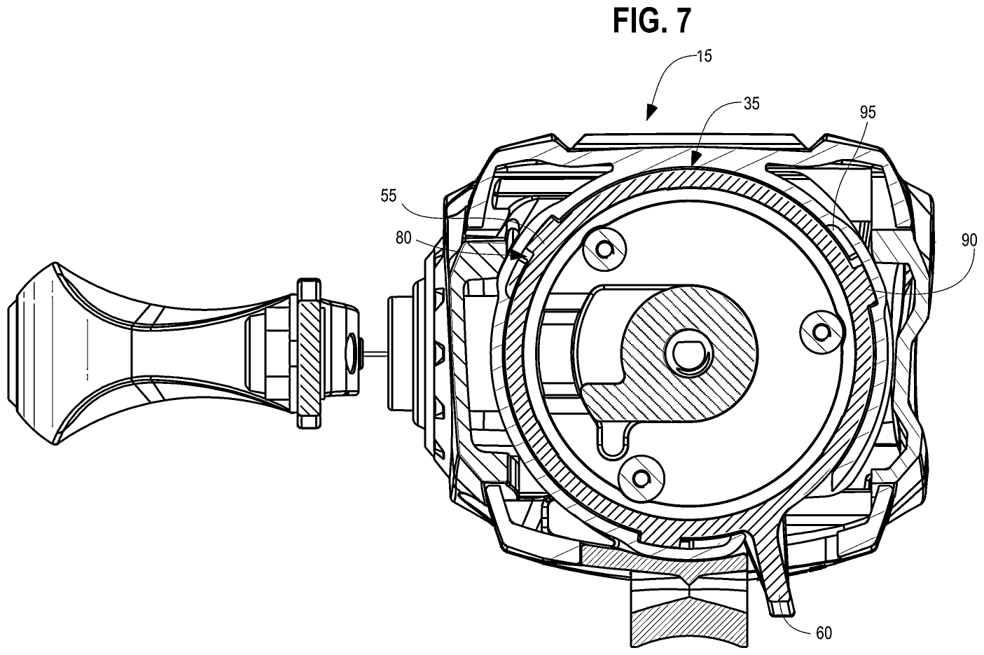

Turning to FIGS. 6 and 7, a user can switch the lock 35 between its locked position (as shown in FIG. 6) and its unlocked position (as shown in FIG. 7) by sliding the knob 60 that extends out of the body 15 and cover 20 to rotate or move the lock 35. As described above, the ring member 50 of the lock 35 may include a rotation limiter 65 that interacts with a corresponding projection or feature of the body 15 to stop rotation of the lock 35 at designated positions. In one preferred embodiment, the lock 35 has its range of rotation limited such that it is in its locked position when it is stopped at a furthest position in one direction of rotation and is in its unlocked position when it is stopped at a furthest position in an opposite direction of rotation even when the cover 20 is not attached to the body 15.

The engagement of the mating surface 40 of the cover 20 with the mounting surface 45 of the body 15 preferably helps prevent rotation of the cover 20. Thus, the cover 20 cannot easily inadvertently rotate such that the slots 80 slide to a position where the cams 55 are in the open portion 90 of the slots 80. Moreover, the lock 35 may be coupled to the body 15 such that it resists inadvertent rotation and instead requires a threshold amount of force from a user to rotate the lock 35. Accordingly, the cover 20 may be secured to the body 15 until a user selectively moves the lock 35 to its unlocked position.

The reel 10 has been described and shown as having the lock 35 attached to the body 15 and having the slots 80 included in the cover 20. In alternative embodiments, the lock 35 could be attached to the cover 20 and the slots 80 could be included in the body 15 to achieve the same effect of selectively securing the cover 20 to the body 15. Similarly, the lock 35 has been shown as including three cams 55 on the lock 35 positioned at approximately equal 120° angles from each other. However, the number of cams 55 could be varied as could the positioning of the cams 55 on the lock 35. Likewise, the number and position of the slots 80 could be varied so long as there are at least as many slots 80 as cams 55 and the slots 80 are positioned such that they can receive the cams 55. In alternative embodiments, it may be preferable to have more slots 80 than cams 55 to provide more user flexibility when installing the lock 35 or attaching the cover 20.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations.

Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The invention claimed is:

1. A spincast reel, the reel comprising:
a spool for holding a line;
a rotor and gear system for retrieving and casting the line;
a main body for housing the spool and the rotor and gear system;
a cover for attaching to the main body and to enclose the spool and the rotor; and
a locking mechanism that includes one or more cam surfaces;
wherein the locking mechanism is assembled onto the main body of the reel, and wherein when the locking mechanism is moved in a first direction, the one or more cam surfaces secure the cover to the main body, and when the locking mechanism is moved in a second direction opposite the first direction, the cover is released from the main body.

2. The reel of claim 1, wherein the cover includes a slot configured to receive a cam surface of the one or more cam surfaces of the locking mechanism.

3. The reel of claim 2, wherein the slot includes a closed portion that receives the cam surface of the one or more cam surfaces when the locking mechanism is moved in the first direction, and the closed portion engages the cam surface of the one or more cam surfaces and prevents removal of the cover from the main body.

4. The reel of claim 3, wherein the closed portion includes a lip proximate a bottom end of the cover, the lip configured to interfere with the cam surface of the one or more cam surfaces to prevent removal of the cover from the main body.

5. The reel of claim 3, wherein the slot includes an open portion that receives the cam surface of the one or more cam surfaces when the locking mechanism is moved in the second direction and permits the cover to release from the main body.

6. The reel of claim 5, wherein one of the locking mechanism and the main body includes a projection and the other of the locking mechanism and the main body includes an aperture for receiving the projection, wherein the cam surface of the one or more cam surfaces is received within the closed portion of the slot when the projection engages a first end of the aperture, and wherein the cam surface of the one or more cam surfaces is received within the open portion of the slot when the projection engages a second end of the aperture.

7. The reel of claim 1, wherein the main body includes a first surface and the cover includes a second surface, and wherein the first surface engages the second surface when the cover is attached to the main body and prevents rotation of the cover relative to the main body.

8. The reel of claim 1, wherein the locking mechanism includes two or more cam surfaces.

9. The reel of claim 8, wherein the cover includes a first slot configured to receive a first cam surface of the two or more cam surfaces and a second slot configured to receive a second cam surface of the two or more cam surfaces.

10. The reel of claim 1 wherein the locking mechanism includes a knob that extends to an exterior portion of the reel, the knob configured to be selectively moved by a user to move the locking mechanism in the first direction or the second direction.

11. A spincast reel, the reel comprising:
a spool for holding a line;
a main body for housing the spool;
a cover for attaching to the main body and to enclose the spool; and
a locking mechanism that includes a primary member and a projection extending from the primary member, the primary member attached to one of the main body and the cover;
wherein when the primary member is moved to a first position, the projection secures the cover to the main body, and when the primary member is moved to a second position, the cover is released from the main body.

12. The reel of claim 11, wherein the other of the main body and the cover that the primary member is not attached to includes a slot configured to receive the projection of the locking mechanism.

13. The reel of claim 12, wherein:
the slot includes a closed portion that receives the projection when the primary member is moved to the first position;
the closed portion engages the projection and prevents removal of the cover from the main body; and
the slot includes an open portion that receives the projection when the primary member is moved to the second position and permits the cover to release from the main body.

14. The reel of claim 12, wherein the projection is one of a plurality of projections, and wherein the slot is one of a plurality of slots configured to receive the plurality of projections.

15. The reel of claim 11, wherein the main body includes a first surface and the cover includes a second surface, and wherein the first surface engages the second surface when the cover is attached to the main body and prevents rotation of the cover relative to the main body.

16. A spincast reel, the reel comprising:
a spool for holding a line;
a main body for housing the spool;
a cover for attaching to the main body and to enclose the spool; and
a lock attached to one of the main body and the cover, the lock having some freedom of movement relative to the one of the main body and the cover that the lock is attached to, the lock configured to selectively secure the cover to the main body;
wherein when the lock is in a first position the lock engages the other of the main body and the cover that the lock is not attached to and secures the cover to the main body;
wherein when the lock is in a second position the lock the lock does not engage the other of the of the main body and the cover that the lock is not attached to and the cover is released from the main body.

17. The reel of claim 16, wherein the lock includes a primary member and a projection extending from the primary member, and wherein the other of the cover and the main body to which the lock is not attached includes a slot configured to receive the projection.

18. The reel of claim 17, wherein:
the slot includes a closed portion that receives the projection when the lock is in the first position, the closed portion engages the projection and secures the cover to the main body; and
the slot includes an open portion that receives the projection when the lock is in the second position and permits the cover to release from the main body.

19. The reel of claim 18, wherein the lock includes a knob that extends to an exterior portion of the reel, the knob configured to be selectively moved by a user to move the lock between the first position and the second position.

20. The reel of claim 16, wherein the main body includes a first surface and the cover includes a second surface, and wherein the first surface engages the second surface when the cover is attached to the main body and prevents rotation of the cover relative to the main body.
